(19) United States
(12) Patent Application Publication
(10) Pub. No.: US 2005/0278202 A1
(43) Pub. Date: Dec. 15, 2005

(54) Information technology transformation assessment tools

(75) Inventors: Matthew T. Broomhall, London (GB); Abigail Thomas, London (GB); Grattan O'Brien, Dublin (IE)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/866,761

(22) Filed: Jun. 15, 2004

(51) Int. Cl. G06F 17/60

(52) U.S. Cl. 705/7

(57) ABSTRACT

Disclosed are assessment tools and related methods for analyzing potential transformations to a business' IT capabilities. In particular, a tool for scoping the potential opportunity incorporating a top-down approach and using previous credentials to make accurate estimations is disclosed. Additionally, a shaping tool employs a bottom-up approach to the assessment based upon more highly-detailed information of the structure of the IT department. Each tool also automatically calculates typical indices for evaluation of the business case of the IT transformation. Optionally, the tools are integrated, and also can automatically generate a business case presentation or a detailed analysis of all data involved in the assessment.

### FIELD OF THE INVENTION

The invention disclosed relates, in general, to assessment tools for assisting the changing of information technology (“IT”) systems, which may typically be managed by departments within the corporate environment. More specifically, the present invention provides automated tools that make it easier for a corporation or other business or entity to transform its IT capabilities in a manner that takes advantage of newer technologies or methods to gain certain anticipated benefits.

### BACKGROUND OF THE INVENTION

Companies in many industries are finding that a strong core IT capability is vital to enable business growth in today's information age. An effective and efficient IT capability can significantly reduce the costs of operating large or small businesses while improving the overall capabilities of the business. As a result, it is becoming increasingly common for businesses to create separate internal departments to handle and oversee internal IT operations and IT growth. These IT departments, though, are faced with numerous new and constantly evolving technologies in a fast paced environment.

The need for change in particular business', corporation's or other entity's IT capabilities can stem from a variety of sources, including financial challenges, customer relations, internal operations, or its organizational structure. Oftentimes, IT departments devolve into departments that experience relatively high costs which lead to low return on investment for the capital spent on IT projects. Reasons for these types of financial challenges vary, but often include an escalating IT cost base, excessively high non-discretionary spending, and poor vendor and contractor management.

Poor customer relations, including low customer satisfaction both externally and internally, are similarly problematic. For example, if employees within the organization are dissatisfied, the IT department can be viewed as a cost center and not as a trusted business advisor. Likewise, breakdowns in IT operations for customer direct-servicing websites and other like customer support functionalities can cause external dissatisfaction, leading directly to losses in revenue.

As IT departments are relatively new to business organizations, organizations can experience situations where it is unclear what the relationship of the IT department is to the business as a whole. Lack of implicit or explicit accountability can lead to IT investments or strategies that unwittingly do not reflect core business needs or serve strategic goals.

Further, the internal operations of an IT department can be another area of challenge. Management shortcomings can lead to lack of clarity on status of current projects or feasibility of future projects, lack of clarity of exact job descriptions and function, substandard project approval processes, and poor resource scheduling processes.

Inefficient organizational structures or management of an internal IT department can lead to higher costs and thus consume in part or in entirety the cost benefits that the IT investments were intended to deliver. For example, if the staff is not equipped with the appropriate skills, knowledge is not properly captured and re-used, career management is inconsistent, or contractors or third parties are over-relied upon, excessive waste can result.

The process for evaluating and implementing large-scale changes in IT strategy, programs or investments, while often necessary, can be of serious financial consequence. Investments in terms of skilled labor hours and IT hardware and infrastructure can be significant for even low-scale IT transformations. Thus, it is important for organizations with significant IT capabilities to make their IT investments translate to improved IT capabilities in the most efficient manner.

To address the shortfalls of an IT department, it is useful to break down a particular IT department to look at its various aspects and thereby identify any problem areas. Importantly, an IT department must have a proper governance structure, such as an IT leadership team, engrained with the appropriate business and technical acumen, and also have department business leadership equipped and motivated to lead the use of IT. Such a proper governance structure should clearly define roles and responsibilities and establish the forums to provide overall direction for its IT department. Proper management and execution processes are formalized, consistently applied, and are results-oriented and value-oriented.

Other important aspects that impact the successful operation of an IT department include proper IT strategy, architecture, and planning, IT development capability, and IT operations infrastructure. Proper IT strategy, architecture, and planning should be tightly aligned with business priorities and provide an aggressive but realistic roadmap to the future. An optimal IT development capability must be predictable and cost-effective for both small, focused efforts and large, complex, multiyear initiatives. Lastly, a successful IT operations infrastructure should be modular, scalable, stable, and secure.

One additional important aspect of typical IT departments includes the supporting processes that are employed by the departments. These processes can include human resources, finance, procurement, and knowledge. Fiscal and financial controls in these processes must successfully enable effective management and deployment of IT assets, resources, and activities in a manner that provides the desired value at an acceptable cost.

In order to improve a business' IT capability, a business may employ various options for improvement ranging from cheap and easy options to relatively more complicated and expensive options. For example, low-level streamlining may be able to reduce some of the costs of an IT department with relatively little investment of time or money. Likewise, if a particular process within, or component of, the business IT capability is underachieving, the replacement or re-engineering of that process or component could potentially save some money. However, in order to maximize the overall effectiveness of the IT department while significantly reducing costs, major changes throughout the entire organization may be required.

“IT transformation” is the large-scale fundamental change to an IT department's processes, technology, and culture with various large scale goals in mind, including reducing costs, improving return on investment, and creating the strong capabilities required for modern IT programs and services. For example, the objectives of an IT transformation may include one or more goals of reducing IT spending while increasing return of investment, improving customer relations and the quality of service, improving delivery capabilities for all services while creating a change-ready culture, and improving internal operations and resource allocation.

Many businesses turn to external consulting firms or other specialists to evaluate their current IT baseline and potential for financial savings and increased efficiency. These specialists are able to capitalize upon their wider scope of past experience and specific IT knowledge to more efficiently direct the business to meet its IT goals. In doing so, the business, in addition to financial payments, gives certain amounts of control of their internal IT department to the external specialists to plan for the future and implement necessary changes. Nevertheless, in order to facilitate such a relationship, as well as plan specific changes, the specialist must have the capability to assess the potential costs and benefits of the IT transformation to the business accurately.

The advantage that an experienced consulting firm or other organization of specialists enjoys cannot be properly used in its assessment of a client or potential client unless such an assessment depends upon the pooled resources and past experiences of various persons of the firm. When a particular specialist or group of specialists within an organization retained as a third party contractor attempts to assess the target business, they presently focus their analysis on the target business in light of their personal experiences. With this type of process heavily dependent upon the personal knowledge of the involved specialists, resources can be wasted in having to do repetitive research work for similar client situations.

Therefore, the problem remains that while a specialist organization's benefit lies in the collective experiences and knowledge capital of its individuals, there heretofore exists no way that past experience can be leveraged and disseminated for application in the assessment of future projects in a simplified manner so as to enable future assessments to be as quick, economical, consistent, and accurate as possible.

### SUMMARY OF THE INVENTION

In light of the above-described and other deficiencies inherent in other assessment processes, it is an object of the present invention to provide assessment tools, platforms, and related methods that save time, improve consistency, and provide simplified access to accurate summations of relevant previous experiences and the knowledge capital of a specialist group, such as a consulting firm, relating to transformation strategies. Such tools and related methods should be capable of dramatically improving the efficiency of and accuracy of assessing the needs of an IT department, including the scoping and shaping of an IT transformation, based upon collective and specific past experiences.

Additionally, it is an object of the present invention that such assessment tools, platforms, and related methods be of such format so as to be useable by any number of people within a consulting firm or other applicable business to evaluate potential changes to an IT department. As such, it is an object that such assessment tools be crafted so as to accept certain information relevant to making a determination of the IT baseline of a business and potential projects to change that baseline. One knowledgeable in IT transformation should be able to take information about the target IT department and be able to use the tools to assess certain projects of or including an entire IT transformation.

Furthermore, it is an object of the present invention to provide automated tools that generate calculations for well-known indices relevant to and useful in the assessment and planning of IT projects, such as return on investment, internal rate of return, and a payback period. Incorporating such calculations into an automated tool that also provides access to compiled and organized knowledge capital relieves a user, such as a specialist, from repetitive functions or having to employ additional tools or applications to obtain such calculations (such as by creating an appropriate spreadsheet whenever the calculations are desired).

To achieve these and other objects, the present invention comprises electronic assessment tools that organize and apply past experiences and knowledge capital regarding the expected financial and efficiency benefits associated with proposed IT transformations, and assist in the creation of accurate assessments and transformation plans. The present invention in one embodiment comprises a first assessment tool in the form of a scoping tool and related methods that enable a high-level, top-down assessment of a potential IT transformation, which can be comprised one or more IT projects. The scoping tool and related methods analyze the high-level information for the purpose of taking a quick, economical, yet accurate, view of the potential benefits of the various potential IT projects that could be included in an overall IT transformation. It applies a top-down approach to scope each IT project of an IT transformation using available financial metrics and baseline statistics in conjunction with project credentials obtained from the experiences of various experts in the field, such as members of a consulting firm specializing in transformation, to give a snapshot projection of the likely outcome transformation projects.

In a preferred version of this first embodiment, the scoping tool and related methods provide a user-friendly medium designed specifically for evaluation of IT departments and changes. The scoping tool is adapted to prompt a user for information or assessments relevant to specific IT project initiatives that the user has selected for investigation. The scoping tool is adapted to receive inputs of data relating to the current status of a target company or organization, and then utilize that information and data inputs to provide comparative analyses of the IT project initiatives that were selected for investigation. These comparative analyses assist the user in selecting only appropriate ones of the IT project initiatives for implementation as part of an IT transformation plan. The scoping tool according to such embodiments incorporates processes to automatically perform all of the typical calculations needed to provide a top level comparative business case for an IT transformation.

The scoping tool and related methods allow a user to take advantage of several features improving the ease to the user and accuracy of the results given the top-down approach. The scoping tool utilizes a library of IT project initiatives, such as projects that can initiate various IT cost reductions and/or service improvements, where the project initiatives are associated with pre-loaded credentials data. The credentials data leverages the know-how and experiences of the user company and thereby aids the process of choosing which project initiatives may be applicable to the IT department of the target organization by estimating the potential effects of those initiatives. The scoping tool also contains historical data regarding previous transformations so as to enable the user to compare how the combinations of certain projects under certain circumstances have impacted similar IT departments in the past. The scoping tool further automatically generates financial projections and a business case for the IT transformation, and can also provide pre-loaded graphs for easy comparison of the IT baseline with and without the transformation.

The present invention further comprises, in a second embodiment, an assessment tool in the form of a shaping tool, and related methods. The shaping tool is focused more in-depth upon the detailed validation of the total potential benefits of an IT transformation, and the costs to achieve them. It incorporates a more detailed bottom-up approach that is based upon more specific information obtained from and regarding the operations of the target organization.

Like the shaping tool, the scoping tool incorporates all of the typical calculations needed to formulate a business case for an IT transformation. The shaping tool provides automatically generated business cases for finalized IT transformation plans, which contain those IT project initiatives selected for implementation, as well as provides graphs to compare the IT baseline with and without the changes adopted in such plans. The shaping tool utilizes additional, more detailed data and makes fewer assumptions than the scoping tool in order to produce a detailed business case and supporting analytical data regarding a finalized IT transformation plan composed of various IT project initiatives.

In a third embodiment of the invention, assessment tools including a shaping tool and a scoping tool are implemented on a shared computing platform such that those particular tools can share a common library of IT project initiatives. In this manner, a user can utilize both tools in a cooperative manner to first investigate various potential project initiatives for inclusion in an IT transformation plan, identify the best initiatives from those investigated given budget, logistical, and other like constraints, and then assemble and generate a complete business case and supporting analysis for a final IT transformation plan.

Additionally, in a fourth embodiment, the user can perform a transformation planning method according to the present invention utilizing the assessment tools. In such embodiments, the user entity, such as consulting firm or other specialist entity performing the transformation analysis, enters relevant financial metrics, IT baseline and current IT projects data into the tool, investigates potential IT project initiatives and explores certain initiatives with the help of assembled historic credentials data, and formulates a finalized transformation plan once a final list of selected IT project initiatives is adopted. At this point, the user is requested to enter additional, more detailed, data regarding the target company necessary to shape the adopted IT transformation plan and prepare various reports summarizing the expected costs and benefits of the transformation plan.

The invention having been thus described in regard to its various embodiments, preferred embodiments thereof will now be described in detail with reference to several figures.

### BRIEF DESCRIPTION OF THE DRAWINGS

FIG. 1 is a schematic diagram depicting one embodiment of the assessment tool as it may be utilized to accept certain information and produce useful, relevant assessments of the impact of an IT transformation.

FIG. 2 is a schematic diagram depicting the assessment system of FIG. 1 with the required classes of information and their sources in a more detailed fashion than in FIG. 1.

FIG. 3 is a schematic diagram depicting another embodiment of the assessment tool and its interaction with certain information to assist in assessment and the shaping of an IT transformation.

FIG. 4 is a flow diagram depicting an IT transformation planning method utilizing the assessment tools according to one preferred embodiment of the present invention.

FIG. 5 is a schematic diagram depicting an electronic platform and intercommunicating computing systems supporting the assessment tools according to one preferred embodiment of the invention.

FIG. 6 is a schematic diagram depicting the assessment system of FIG. 1 including two optional modules for generating certain outputs for use in the assessment of an IT transformation.

FIG. 7 is an illustration of one project initiative selection user view produced by the assessment tools according to preferred embodiments of the present invention.

FIG. 8 is an illustration of one user view for initial scoping of a selected potential project initiative as produced by the assessment tools according to preferred embodiments of the present invention.

FIG. 9 is an illustration of one user view for displaying outputs that describe the shaping of a project initiative as produced by the assessment tools according to preferred embodiments of the present invention.

FIG. 10 is an illustration of one user view for displaying the cost reductions calculated by the shaping of a project initiative as produced by the assessment tools according to preferred embodiments of the present invention.

FIG. 11 is an illustration of one user view for displaying stored credentials data relating to project initiatives as may be produced by the assessment tools according to preferred embodiments of the present invention.

### DETAILED DESCRIPTION OF THE PREFERRED EMBODIMENTS

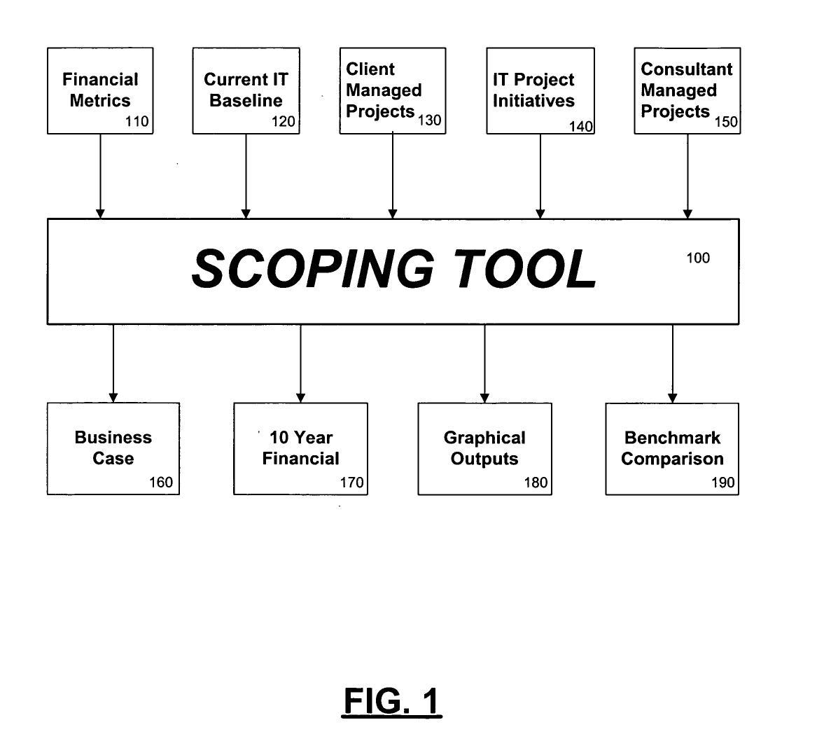

An example of a first assessment tool according to the invention, scoping tool 100, which embodiments of the present invention may advantageously employ, is conceptually depicted in the schematic diagram of FIG. 1. Scoping tool 100 comprises groups of interrelated and interdependent computing processes that employ formulas and calculations to interpret and manipulate various input data regarding a target organization or business (i.e., an organization of businesses for which IT transformation is desired) in light of previous IT transformations and associated accumulated credentials data to produce various diagnostic data and graphical outputs. These scoping tool outputs can then be used by a user, such as consulting firm, or other specialist organization to scope an IT department of the target business to assess the expected outcome of the components of a potential IT transformation that is under consideration. Scoping tool 100 is preferably automated by routines operating on one or more computer platforms as will be further understood from the discussion below. The formulas and manipulations used on the input data stem from and depend upon, among other things, the knowledge gained by the user organization from prior IT project initiatives and transformation plans and the results of these prior projects and plans in view of different factors.

As depicted in FIG. 1, the scoping tool 100 manipulates certain data that can be conceptually divided into several groups of inputs. Generally speaking, the more information that can be provided from the target company into the scoping tool 100 via these inputs, the more accurately the scoping tool 100 can assess the potential IT transformation. Oftentimes, however, it is difficult or inefficient to obtain much information from a target company at the initial planning stages of a transformation. Therefore, the scoping tool 100 is adapted such that it is not imperative that a user has enough information to enter data into every possible field. The scoping tool 100 is adapted to use as much actual data as possible, with the caveat that more data inputs will typically result in more accurate outputs for analysis and comparison.

The first category of inputs as depicted in FIG. 1 comprises financial metrics 110. Financial metrics 110 are the key model drivers for the business. Background information such as the business' name and industry as well as unit of currency is entered here. The general financial information may include statistics such as overall revenue, market value of debt and equity, pre-tax cost of debt, corporate tax rate, market risk premium, overall revenues, and the like. These statistics will influence most or all of the outputs, and are thus important to the scoping tool 100.

Specific financial metrics 110 can include IT baseline cost type metrics and information about the groups within the IT department. The IT baseline cost type metrics includes cost growth rates and asset information regarding the IT department's people, hardware, software, voice networks, data networks, and facilities. The cost growth rates are key drivers of the net present value outputs, as described later. The financial metrics inputs relating to the details of the IT department particulars preferably have default settings assigned by the tool (based upon the experience of the user organization and in case such information is not readily available at the initial transformation planning stage). These default settings, of course, can be changed to reflect actual data values, such as salaries of groups such as management, or costs of delivery, implementation, control, operations, support, finance, and human resources, if available.

The second set of inputs, current IT baseline 120, is used to capture the IT spending of the target business. One of the typical goals of any IT transformation is to minimize to the extent possible the spending costs of the IT department. The current IT baseline 120 takes into account both operating expenditures as well as capital expenditures. While internal personnel expenses, voice networks, and data networks fall into the operating expenditures category, items such as hardware, software, and facilities can fall into either or both categories. Additionally, external staff or independent contractors can be a capital expense. The operating costs associated with any of these items typically stem from one or more of the following: payroll, depreciation, rent, lease, license, and maintenance. The scoping tool is thus adapted to seek data regarding each of these types of operating costs to utilize in scoping an IT transformation.

The third set of inputs, client-managed projects 130, is used to capture data describing the cost and duration of non-routine IT projects that are already managed by the business. They need not include routine or normal projects that are in the ordinary course of business. If the business has no current or near future plans for such projects, there could be nothing to enter into the client-managed project 130 queries. Simply for illustrative purposes, a possible non-routine IT project could include an ongoing project by a European business to convert its IT systems from an earlier currency to accept Euro inputs. The purpose of the scoping tool incorporating these projects is to show the effect on spending on projects that the target business must complete or intends to complete either with or without the consulting firm.

For each such client-managed project that does exist, several parameters are necessary. Initially, the starting date, month, or quarter and the projected ending date, month, or quarter are required to assess the duration of the impact on the IT department. Furthermore, costs associated with the projects may be incorporated into the scoping tool 100. Such costs shall include capital and operating expenses similar to the categorized inputs in the current IT baseline 120 inputs.

As depicted and described in further detail below, the scoping tool 100 incorporates or is connected to a library of IT project initiatives that can provide benefits to the target company, such as by reducing IT related costs, improving IT effectiveness or efficiency, eliminating duplicate or unnecessary IT functionalities, or introducing new cost-effective IT functionalities. Such project initiatives are largely derived from the experiences of members of the user organization, and include the procurement and installation of data storage consolidation technologies, workstation standardization efforts, external resource provider reduction, and the like. The library may or may not be organized by aggregating related initiatives into various categories for ease of reference.

IT project initiatives inputs 140 utilized by the scoping tool 100 leverage the knowledge capital of the user's specialist organization to a large extent. These inputs are dependent upon project initiatives selected from the initiatives library ranging, for example, from consolidation of data centers to standardization of workstations. Based upon whatever knowledge is available at the time of the business' current IT department, the user selects those ones of the initiatives available in the library that could apply to the target business in a manner that potentially would improve its IT department. For each selected initiative, the user would preferably be asked to enter projected timelines for the start and completion of the task as well as information to calculate rough projected costs.

In the process of exploring and selecting the IT project initiatives, the user could be presented with automated prompts by the scoping tool to guide the user to enter various quantitative and qualitative information or assessments. Initial qualitative assessments, such as in the form of the tool requiring answers to key yes or no questions, are provided to assist the user in easily identifying whether a particular initiative is a suitable candidate for analysis. Should the user decide that one of the initiatives will be to standardize workstations, the scoping tool 100 could, for example, request as an initial input: whether or not the business uses multiple suppliers for the lease or purchase of the workstations, whether there is a control procedure for workspace images, whether the business uses multiple operating systems, and whether the business' current workstations are nearing the end of their useable lifespan. These initial inputs requested in conjunction with each initiative are associated with algorithms that reflect the composite knowledge capital and experience of members of the specialist organization, and, once these inputs are entered, the user could be provided with initial feedback to determine whether that initiative has potential to help improve the target company. After the initial inputs, further information could be requested and then analyzed in light of credentials data associated with the particular initiative. The credentials associated with each particular project initiative are derived from the user entity's collective industry experience. The scoping tool 100 can compute ranges or estimates of expected savings and/or costs based upon the answers to these questions. Furthermore, the user would typically be requested to enter financial figures relevant to the cost impact over the span of several years to each group within the IT department.

The final set of inputs include relevant data regarding any the consultant-managed projects 150. Each potential project selected is entered into this section as well as information such as timelines and expected financial impacts. The tasks associated with these projects inevitably cost at least some money to the target business upfront, but are intended to produce a savings in the future with as short a pay back period as practicable.

As stated above, scoping tool 100 preferably uses an automated software platform to perform the computations. Software packages make the scoping tool 100 appreciably easier to use by providing user-friendly forms for each group of the data inputs and by automatically calculating the outputs and displaying them in preferred formats that are easy to view and/or print. In the most preferred embodiment, the scoping tool 100 will use EXCEL or another suitable commercially available spreadsheet as its platform. The formulas can be programmed into the spreadsheet in a manner such that a user need not be involved with their computations other than simply entering the requisite inputs when prompted. It is further preferable that the platform can constantly update the outputs and results as more or different input data is entered such that the user can get an idea about how the outputs will be influenced by certain entries. For example, each group of data inputs can be placed upon a different sheet, and the user can navigate between them. Or, in the alternative, macros can be programmed to allow for buttons or other methods of navigation through the entire spreadsheet including any introductory overview, the inputs, and the outputs. The graphical outputs are also automated and will preferably update with an input or changes in the input. This way, if a user chooses, multiple graphs can be easily obtained to demonstrate the difference in benefit from different initiatives.

Turning now to the outputs of the preferred embodiment of the scoping tool 100, the first set of outputs is a business case 160. The business case 160 shows detailed projected IT spending for the next ten years into the future for the business with and without the help of a proposed IT transformation plan (containing the selected IT project initiatives) to be managed by the consulting firm. Similar to the categories of inputs, the business case 160 preferably is broken down into operating costs and capital costs. The operating costs can include categories such as: people or personnel, hardware, software, voice networks, data networks, facilities, and other. Each category preferably then further is separated into payroll, rent/license/lease, maintenance, and other. The capital costs include IT capital expenditures as well as projected capital costs for hardware, software, external staff, and other.

Importantly, the business case output 160 provides summary comparisons of the situations with and without the aid of the specialist organization and its proposed IT transformation plan. The comparisons include typical numbers important in the decision making process. By way of example, these comparisons can include cash flow difference, cumulative difference, discounted difference, cumulative discounted difference or net present value, internal rate of return, and payback years for the entire IT transformation, and optimally with a break down for each individual selected initiative within the potential transformation plan.

The second set of outputs, the ten-year financials 170, is a detailed look into exactly what the expected spending will be over the course of the following ten years under the proposed plan. As with the business case outputs 160, the ten-year financials 170 depict the costs broken down into similar categories. Additionally, though, the ten-year financials 170 show recurring operational impact, one-time operational costs, and depreciation schedules.

Additionally, graphical outputs 180 are generated by the scoping tool 100 to provide results in an easy-to-read manner. While graphs can possibly b be made for any numerous comparisons and results, for convenience sake, it is preferable that the scoping tool 100 generates only a limited selection of the relatively more informative graphs automatically. In one particular preferred embodiment, the following graphs are provided: comparative IT spending projection, IT baseline savings, estimated savings with net present value and internal rate of return, estimated benefits and costs of the IT transformation, estimated annual benefits by source, estimated annual benefits, benefits realization profile, internal IT project initiatives, IT operations baseline projection, IT baseline savings detail, and IT headcount reduction.

The benchmark comparison 190 compares the target business' IT department and spending habits against IT department numbers for other similarly situated businesses. This aids the business, before spending the money on an IT transformation, to understand how much other companies are spending on similar activities. The benchmarks may be provided by an external company, such as GARTNER Inc., and can be supplemented by internal proprietary data further reflecting internal know-how of the user entity.

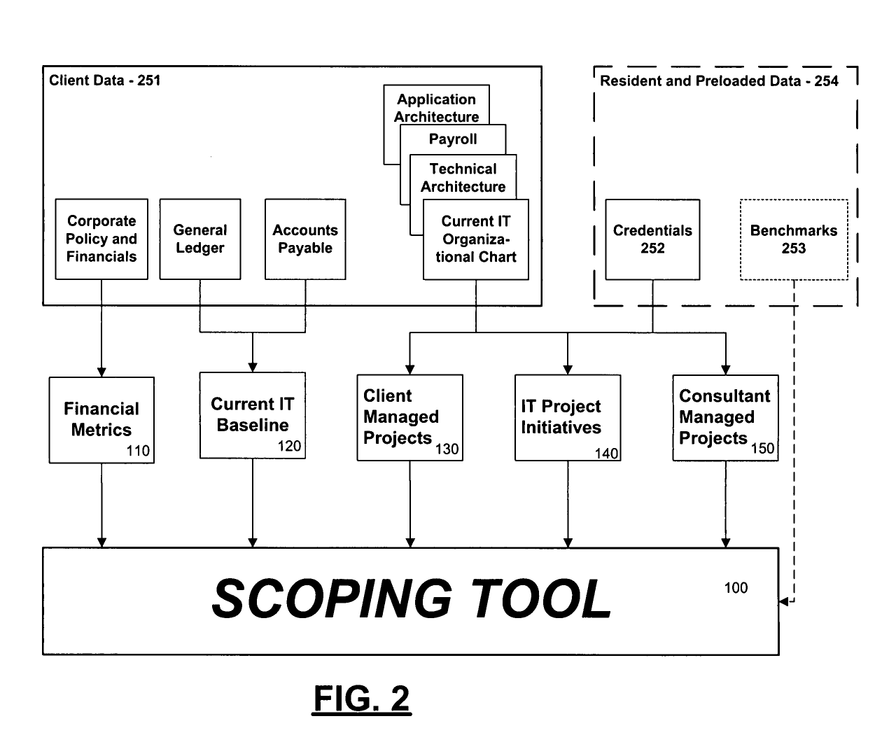

Turning now to FIG. 2, the various types of information required to use the scoping tool 100 are conceptually depicted in the schematic diagram in further detail relative to FIG. 1. As shown in FIG. 2, the scoping tool 100 uses information from three sources. A first source, client data 251, comprises information taken from various sources within the target organization and, as depicted, provides data needed by all five input groups 110-150. The more client data 251 that is available to be used by the scoping tool 100, the more accurate assessment of an IT transformation can be produced. While the client data 251 does include some basic overview financials for the financial metrics input 110, it is mostly driven by specific data, financial and otherwise, regarding just the IT department. As depicted, corporate policy and financials information from the target organization are utilized to assemble and enter requested financial metrics inputs 110, and general ledger and accounts payable information are likewise utilized to assemble and enter current IT baseline inputs. Client managed projects inputs 130, IT project initiatives inputs 140, and consultant managed projects inputs 150, as depicted, are assembled and entered from various other client data sources, including the client's application architecture, payroll, technical architecture and current IT organization chart. The client data 251 is both quantitative and qualitative. Examples of potential qualitative information can include organization chart, architecture, and planned project information.

Additional input data utilized by the scoping tool 100 as inputs can be derived from resident and preloaded data sources 254, which, unlike client data source 251, do not depend specifically upon the particular target company. A first one of the sources 254 include past experience credentials 252 which are used by the tool 100 in conjunction with the client-managed projects inputs 130, IT project initiatives inputs 140, and the consultant-managed projects inputs 150 as depicted. The impact of each project of an IT transformation can be more accurately forecasted using these credentials 252 as the credentials provide baseline comparison date from similar IT projects that were previously implemented by other companies.

One or more sources of benchmarks 253 are not directly incorporated as inputs per se by the scoping tool 100 because the scoping tool 100 simply compares the target business' current IT spending numbers with benchmark data for other similarly situated companies (such as companies from similar industries, having similar IT needs, markets, etc.). As indicated above, such benchmarks 253 can include GARTNER industry data and/or internal benchmarks adopted by the user's organization.

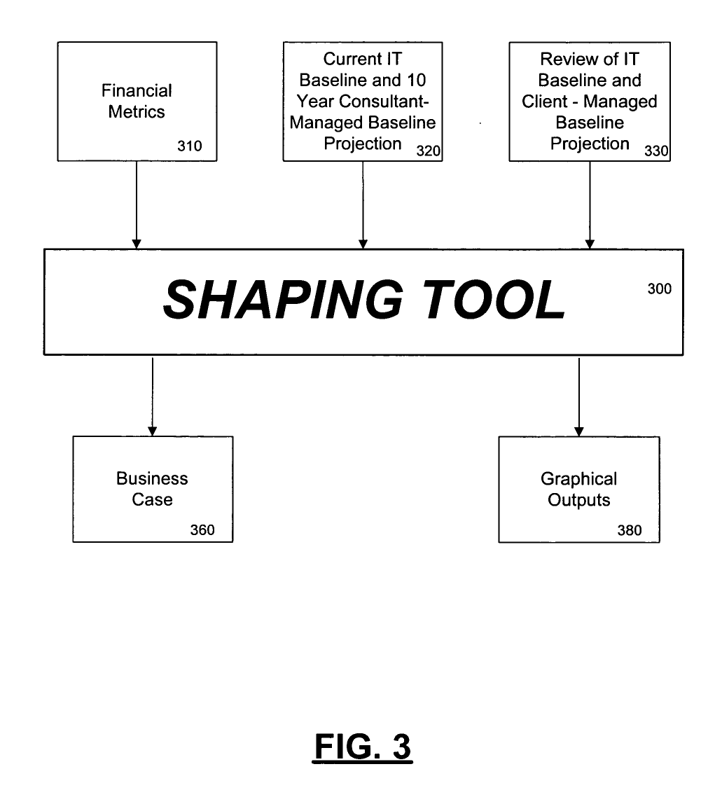

FIG. 3 is another schematic diagram, which conceptually depicts another embodiment of an assessment tool, namely a shaping tool 300. Shaping tool 300 comprises groups of interrelated and interdependent computing processes that employ formulas and calculations to interpret and manipulate detailed input data regarding a target organization in light of the same credentials data to produce the various diagnostic data and graphical outputs. These outputs can then be used by a user organization to shape a transformation plan for the IT department of the target business after a finalized IT transformation plan, containing particular project initiatives that have been selected, has been adopted. The shaping tool thereby allows the user to provide a detailed forecast regarding the expected outcome of a planned IT transformation. Shaping tool 300 likewise may be automated by routines provided with various computer platforms as described above in reference to the scoping tool 100. The formulas and manipulations of the input data stem from, among other things, the knowledge gained from past IT transformations and their results based upon several different factors and initiatives. While similar to the scoping tool 100, shaping tool 300 requires highly detailed inputs and produces more reliable outputs.

As opposed to the scoping tool 100, which may provide an easier way to view the expected outcomes from individual projects, the shaping tool 300 is meant for use after at least preliminary decisions have been made about which specific projects will be part of the IT transformation. Also, while the scoping tool 100 aids the user in estimating and calculating the potential benefits from certain projects and weeding out originally selected project initiatives that do not appear to be profitable or otherwise desirable, shaping tool 300 requires more on the part of the user to apply what has been already estimated to produce a more accurate forecast.

The first set of inputs for shaping tool 300 is the financial metrics 310. The financial metrics 310 include basic financial information about the business including the business' name, unit of currency, revenue and discount rate. The financial metrics 310 for the shaping tool 300 also require IT personnel information, such as a head count and cost per head, both of internal employees and outside contractors, of such groups as IT management, solution delivery, service implementation, control, delivery, support, commercial operations, finance, and human resources, to the extent that these groups exist within a given business' IT department. Further, financial metrics 310 would include the cost growth or reduction rates for the following: people, hardware, software, voice networks, data networks, facilities, and other.

Current IT baseline and ten-year consultant-managed baseline projection inputs 320 for the shaping tool 300 are more detailed compared to the current IT baseline inputs 120 of the scoping tool 100. The inputs are split into capital expenditures and operating expenditures, and within each broken down into several categories. For each category, specific, detailed information is required. For example, under hardware operating costs, information regarding depreciation/amortization, rent/lease/licenses, maintenance, and other, while under people or personnel, the required information is further broken down by role, headcount, and expenses. The data and information used in conjunction with the current IT baseline and ten-year consultant-managed baseline 320 incorporate the consultant-managed projects for the subject IT transformation plan. This is the projected baseline as desired during and after the IT transformation.

The third set of inputs for the shaping tool 300 is the review of IT baseline and client-managed baseline projection 330. This set of inputs is geared to forecasting the baseline costs if the business continues to operate its IT department without outside aid of the specialist organization. As a starting point, the current information about the IT department is used as well as the target business' projection or the consultant's projection of how costs will elevate or decline over the next up to ten years. Projects that can be included here typically are projects that the business must undertake with or without the aid of an outside consultant. For example, if certain workstations' useful lives are to end in two years, then they must be replaced regardless of who oversees the actual project. Again, the review of IT baseline and client-managed baseline projection inputs 320 for the shaping tool 300 require more detailed and in depth data that was necessary for comparable calculations performed by the scoping tool 100.

In the depicted embodiment, the shaping tool 300 has two sets of outputs. The first output is the business case 360. The business case 360 includes a summary listing of the projected baseline for the business with and without the consultant-managed IT transformation. Also included in the business case 360 are baseline comparisons such as cash flow difference, cumulative cash flow difference, discounted difference, cumulative discounted different or net present value, internal rate of return, and payback period.

The graphical outputs 380, like graphical outputs 180, provide results in an easy-to-read manner, and can be ma be b de for any numerous comparisons and results. In one preferred embodiment, the following graphs are provided: comparative IT spending projection, IT baseline savings, estimated IT transformation program savings including net present value and internal rate of return, estimated benefits and costs of the IT transformation, estimated annual benefits by type, IT operations baseline projection, IT baseline savings detail, and IT headcount reduction.

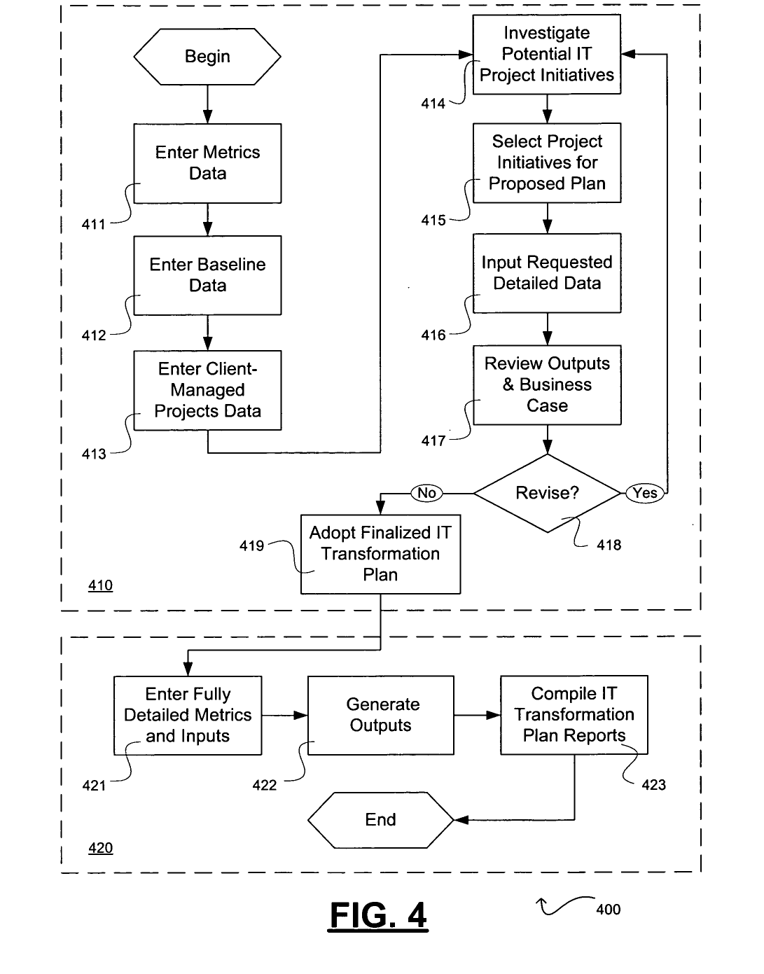

Preferred embodiments of the assessment tools having been described in conjunction with FIGS. 1-3, FIG. 4 depicts an IT transformation planning process 400 that utilizes tools 100 and 300 according to one preferred embodiment of the present invention to investigate the IT situation of a target company, design an appropriate IT transformation plan, and implement that plan. As depicted in FIG. 4, planning process 400 can be broken down as comprising in large part two different IT sub-processes. The planning process 400 begins with a scoping sub-process 410, which is performed by a member of the specialist organization employing a scoping tool 100 as described herein. Scoping sub-process 410 begins with the user entering metrics data 411 and entering baseline data 412 into the scoping tool 100 per the prompts and/or forms provided by the tool. As described above, such data can be obtained from various sources, including financial documents of the target organization, other existing documentation of the target organization, and interviews with relevant employees of the target company. The user also enters information regarding client-managed baseline data at 413. After entering the data obtained from the client into tool 100, the user is ready to begin considering which types of IT improvement projects should be incorporated into a proposed plan for transforming the IT department operations of the target company.

The user thereafter investigates the details of potential IT project initiatives at 414 by browsing the library of IT initiatives made available through scoping tool 100. As described generally above, this library of IT project initiatives contains accumulated historic information and data regarding projects that could potentially initiate various IT cost reductions and/or service improvements within the target company (i.e., “project initiatives”). For example, the projects can be of various types that would provide one or more benefits to the target company, such as by reducing IT related costs, improving IT effectiveness or efficiency, eliminating duplicate or unnecessary IT functionalities, or introducing new cost-effective IT functionalities. The project initiatives contained in the library are supplemented with credentials data derived from the experiences of members of the user organization. The credentials data helps leverage practical experiences regarding each particular project initiative, and provide the user with relevant information to assist in the process of choosing which project initiatives may be applicable to the IT department of the target organization by estimating the potential positive effects of those initiatives. After investigating project initiatives in light of the credentials data, the user then selects at 415 one or more of the project initiatives for inclusion in a proposed IT transformation plan. To better illustrate how a user would employ the scoping tool according to planning process 400 to investigate potential IT project initiatives and select those initiatives for a proposed transformation plan, as well as to demonstrate how credentials data is utilized in the process, several possible user views of the scoping tool 100 will now be discussed.

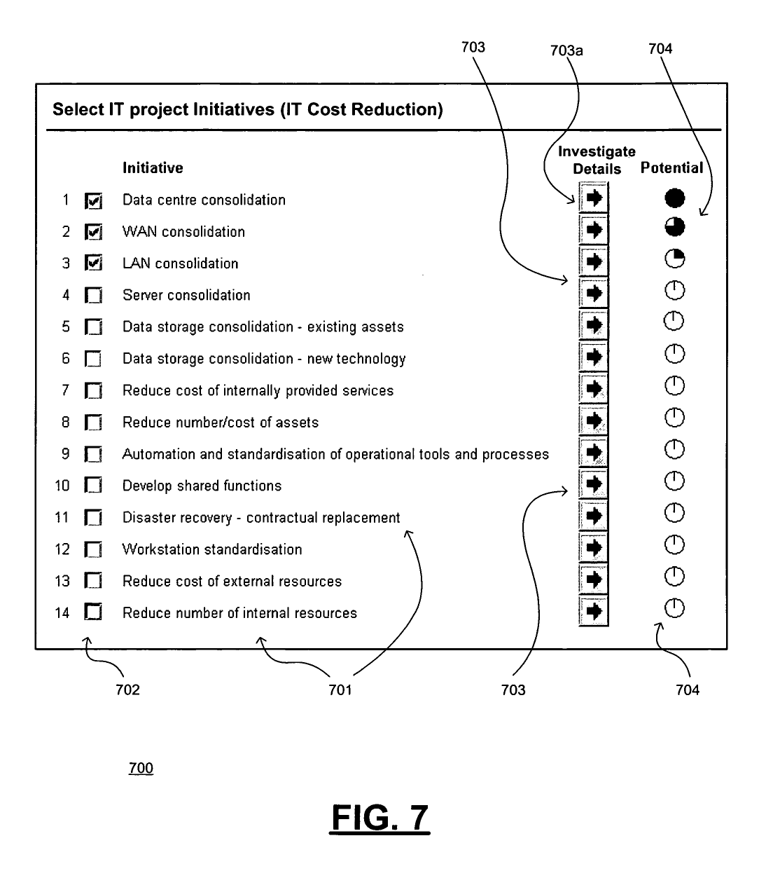

FIG. 7 is an illustration of one project initiative selection user view 700 produced by the assessment tools according to a preferred embodiment of the present invention. As noted above, the IT project initiatives library may or may not be organized by aggregating related initiatives into various categories for ease of reference. User view 700 provides the user with a listing of IT project initiatives that are candidates for reducing costs of the target company's IT department. Such cost reduction project initiatives generally could pertain to the procurement and installation of data storage consolidation technologies, workstation standardization efforts, external resource provider reduction, and the like. Other similar user views for selecting other project initiatives (pertaining to other groupings of project initiatives that are related in either purpose or action) could be accessed within the scoping tool or, alternatively, all project initiatives in the library could made be accessible via a single user view (such as by using scroll bars, exploding/collapsing lists, etc.). This selection user view 700 as depicted lists fourteen different project initiatives 701, each of which are provided with a graphical indicator 704 that provides a quick visual indication regarding the potential of the associated initiative (i.e., potential for high impact or low impact on cost reduction).

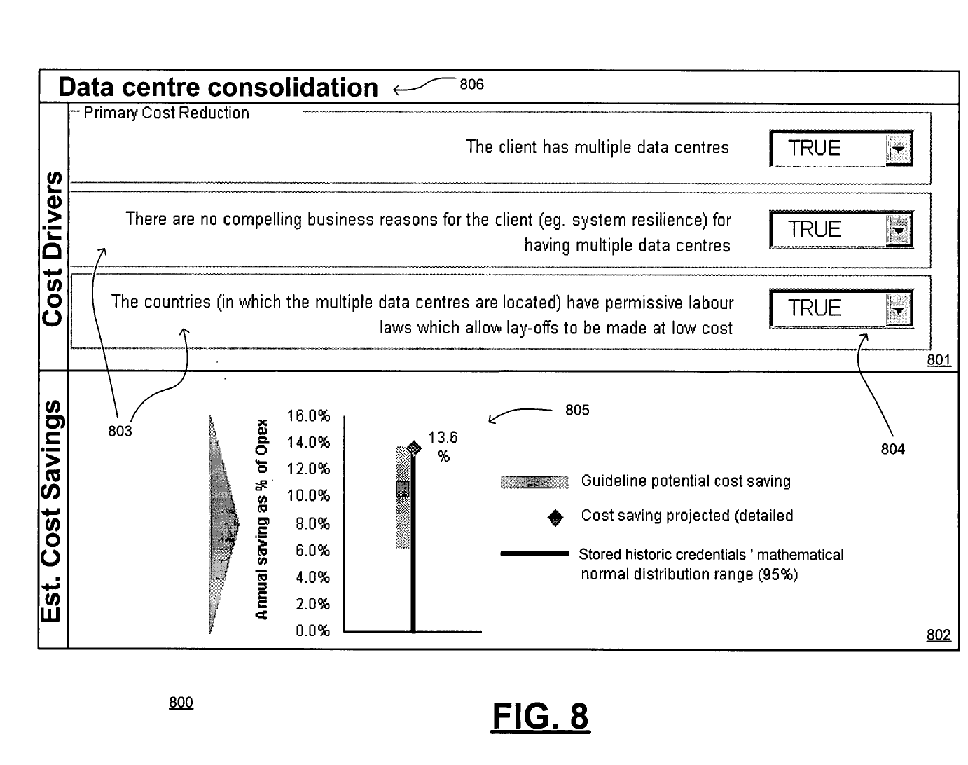

While browsing the project initiatives 701 via user view 700, the user is also able to investigate the details of a particular interesting initiative by clicking on a button 703 provided for each listed initiative. Selecting any one of the buttons 703 would cause the scoping tool 100 to display more detailed overview information derived from the practical experiences of the specialist organization with respect to the project initiative being investigated in order to help the user in deciding whether to select that project initiative for inclusion in a proposed transformation plan. FIG. 8 illustrates an overview information user view 800 as produced by the scoping tool 100 in a preferred embodiment of the present invention after the user has selected button 703a.

In particular, overview information user view 800 provides a title 806 indicating the particular name of the project initiative for which the user has selected to investigate details (the particular project initiative in this example being “Data centre consolidation,” the first initiative 701 listed in user view 700). The overview information user view is broken into an assessment input entry section 801 (labeled “cost drivers”) and an estimated impact section 802 (labeled “cost savings”). In the assessment input entry section 801, the user is asked to answer several relatively high-level questions 803 regarding the target company, such as by selecting one of several permitted answers from a pull-down menu 804. The answers provided to the questions 803 cause the tool to automatically generate impact information 805 displayed in the estimated impact section 802. The impact information 805 provides the user with a rough estimate regarding what kind of benefit could potentially be obtained from the particular project initiative if implemented by the target company. In the example depicted in FIG. 8, the impact information comprises a chart that shows cost savings for the project initiative, where the chart compares how the projected potential cost savings of the target company (determined from the answers to questions 803) fares within the distribution of results obtained by previous similar projects as measured by the current credentials data. Preferably, the impact information 805 provides an initial recommendation (such as whether the target company's situation appears to fall within a range of positive results linked to the particular initiative) regarding whether the particular project initiative should be further considered for inclusion in a transformation plan for the target company or disregarded.

Upon viewing the impact information 805, the user could return to project initiative selection user view 700 where that user could then navigate to additional overview information views for other project initiatives of interest. After investigating project initiatives 701, the user could then decide which of the investigated initiatives to include in an initial proposed transformation plan and select those ones using the various selection check-boxes 702 provided beside the listed project initiatives 701 (selected initiatives being designated in conventional manner by displaying a check within a selected check-box 702). In this manner, various project initiatives can be investigated and selected for further review using scoping tool 100 according to sub-process 410.

Referring again to FIG. 4, after investigating potential IT initiatives within the library and selecting particular ones for inclusion into a proposed plan, scoping sub-process 410 of planning process 400 thereafter continues with the user being prompted for and entering detailed scoping information and data 416 specifically requested by the scoping tool 100 for the project initiatives selected previously above at 415. As described above, the data requested for each project initiative would differ, and the scoping tool 100 would be adapted to automatically prompt the user only for information necessary (or helpful, as default estimates or answers could be provided in some instances) to scoping the collective impact of the currently selected IT project initiatives within the proposed transformation plan. This requested data would therefore relate to consultant managed projects inputs 150, as depicted in and described with respect to FIG. 1 and FIG. 2.

After the detailed scoping information and data is entered, the scoping tool 100 automatically generates outputs 160-190, as described above. The user reviews these various generated outputs at 417 with the goal of determining whether the proposed IT transformation plan is suitable for finalization. After reviewing the generated outputs of the scoping tool at 417, the user decides at 418 whether to revise or adopt the proposed plan. If the plan appears to be unacceptable, such as by, for example, significantly exceeding an initial budget limit, the user could elect to revise the plan by returning to investigating and then modifying the selected project initiatives, as depicted. This re-investigation and re-selection would be followed again by subsequent entry/modification of detailed scoping information and review of the generated scoping tool outputs, as depicted. This loop would repeat until the proposed transformation plan, containing a final combination of various selected project initiatives, is approved by the user and adopted at step 419, thus ending scoping sub-process 410.

Planning process 400 continues with the initialization of shaping sub-process 420. The shaping sub-process 420 is performed by a member of the specialist organization using a shaping tool 300 as described herein to assist that user in shaping the proposed rough transformation plan adopted above at 419. For ease of use, the shaping tool 300 is preferably electronically connected to or otherwise integrated with the scoping tool 100. In this manner, both tools can utilize a common library of project initiatives and associated credentials data. Furthermore, integration allows the scoping tool 100 to pass all inputs 110-150, including all financial data, projected data, quantitative assessments, and selected project initiatives and the resulting outputs to the shaping tool 300. Therefore, in this manner many inputs required by the shaping tool can be automatically populated, simplifying the task of the user greatly.

Shaping sub-process 420 nevertheless begins at 421 with the shaping tool 300 requesting the user to input the necessary remaining data entries not entered previously during the scoping sub-process 410. As with the scoping tool, this data entry can utilize spreadsheets, forms, drop-down menus, and other conventional data entry means. Once entry of fully detailed input information is complete, the shaping tool will automatically generate a complete business case and supporting graphical outputs at 422. At this point, the user can then review the various outputs and then utilize various tool macros to compile at 423 selected output data into various formats (such as written report documents, slideshow presentations, presentation graphics, and the like) for printing or exportation to external software applications (such as a word processing or presentation program). At this time, shaping sub-process, and thus planning process 400, ends.

It should be readily appreciated by one skilled in the art that shaping sub-process 420, while not being depicted as being iterative in nature like sub-process 410, can be repeated at various times whenever the user desires to obtain updated business case projections for the ongoing IT transformation being performed according to the finalized plan. In this manner, the user can update the inputs fed into the shaping tool when revised or more accurate data becomes available (such as a few weeks or month into implementation of the finalized IT transformation plan), in order to obtain more accurate business case information and to prepare updated reports, presentations, and the like.

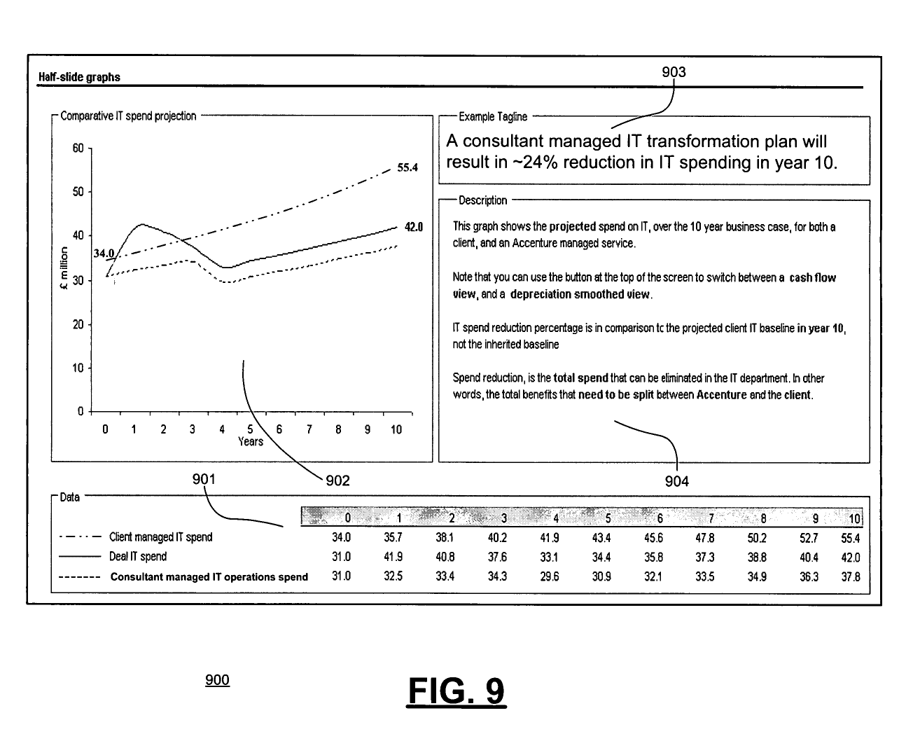

To better illustrate how a user would employ the shaping tool according to planning process 400 to review the various generated outputs, several possible user views of the shaping tool 300 will now be discussed. FIG. 9 is an illustration of a graphical output user view 900 that displays particular information relating to a shaped IT transformation plan according to one preferred embodiment of the present invention. The output user view 900 provides the details of a particular metric or measure (the metric depicted being comparative projections of IT spending). Different, but similar graphical output user views could be accessible via the shaping tool for various metrics and measures computed by the tool. The output user view 900 provides a data table 901 regarding spending projections at the bottom of the view, and also provides a viewable graph 902 of that data automatically. The user can export, or preferably “copy” and “paste,” the data table 901 or the graph 902 into a desired word processing, spreadsheet, graphics, or presentation application to for subsequent use. The output user view 900 also preferably provides a text tagline 903 describing the findings with respect to the subject metric or measure, which can be incorporated as a caption for the graph in reports and presentations or otherwise utilized by the user. Preferably, the output user view 900 as depicted has a description portion 904 that provides a more detailed background regarding what the particular metric or measure represents, how it is calculated or measured, and the like. Like the data table 901 and graph 902, shaping tool 300 is adapted such that the user could export or cut and paste the contents of the tagline 903 or description portion 904 as desired.

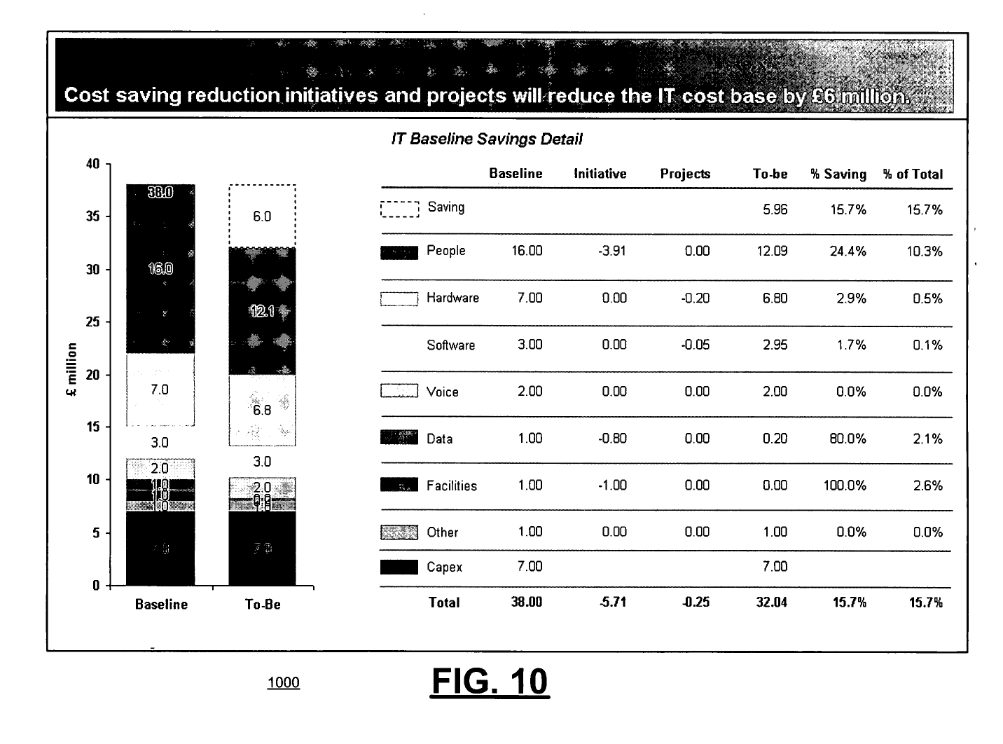

Referring now to FIG. 10, there is illustrated a business case output user view 1000 view for displaying particular information relating to a shaped IT transformation plan according to a preferred embodiment of the present invention. Output user view 1000 provides the details of the projected IT cost reductions calculated by the shaping of the finalized IT transformation plan. As shown in FIG. 10, the user view 1000 provides detailed breakdowns as present in a business case regarding the various sources of IT costs. Various different user views, breaking down each particular source (such as “Voice” or “Facilities”) and the related computations and data incorporated into the projection of each, can be provided by the tool. Such different user views, for example, could be navigated to be clicking on particular names, data, or figures within user view 1000, and the data could be exported into various formats, including expansive data spreadsheets demonstrating the underlying calculations.

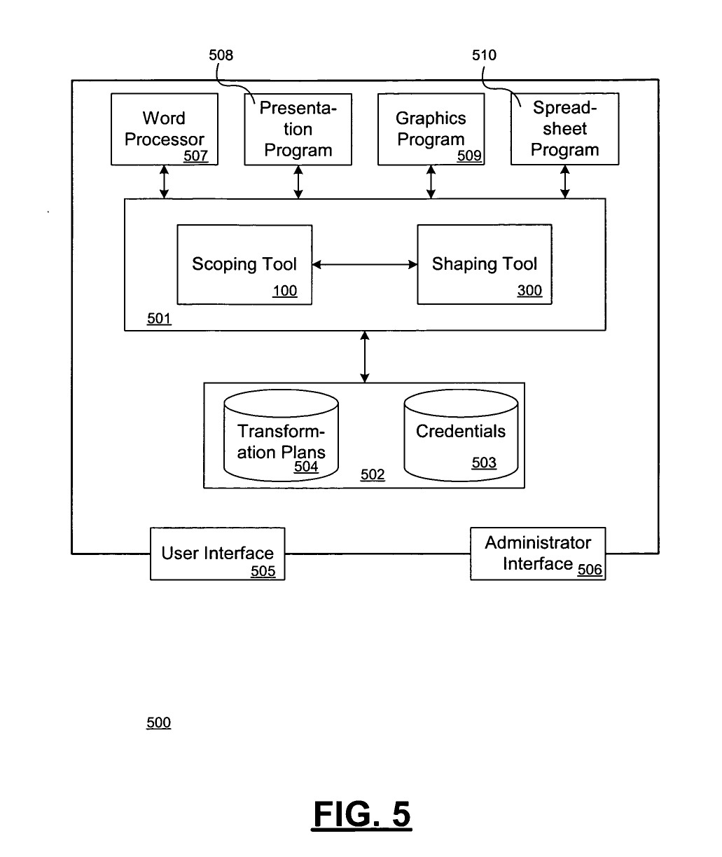

The embodiments of the two tools and related process now being described, an embodiment of the invention comprising an electronic platform and intercommunicating computing systems supporting the assessment tools is depicted in FIG. 5. As shown in FIG. 5, assessment system 500 comprises a computer network comprising servers, databases and other storage units and the necessary software and integration hardware to make the system an operational computing platform. Central to the assessment system 500 is an integrated assessment tool 501, formed from the two assessment tools as described above, the scoping tool 100 and the shaping tool 300. The integrated assessment tool 501 can contain all the functionalities of the two tool embodiments as described above, and is in electronic communication with a data storage system 502, comprising one or more data storage devices upon which are stored files and/or databases. The data storage system 502 stores at least credentials data files 503 and transformation plans data files.

The credentials data files can include all the project initiative and related credentials data used by the integrated assessment tool 501. For example, credentials data can be maintained in a database or flat file that can be updated via an appropriate form accessible by an administrator or other authorized user (such as through an administrator interface 506 or a user interface 505) via the assessment tool 501. Data entered into the integrated assessment tool 501 during scoping and shaping is stored in transformation plan data files 504 in the data storage system such that scoping and shaping activities can be saved, revisited, and modified as desired.

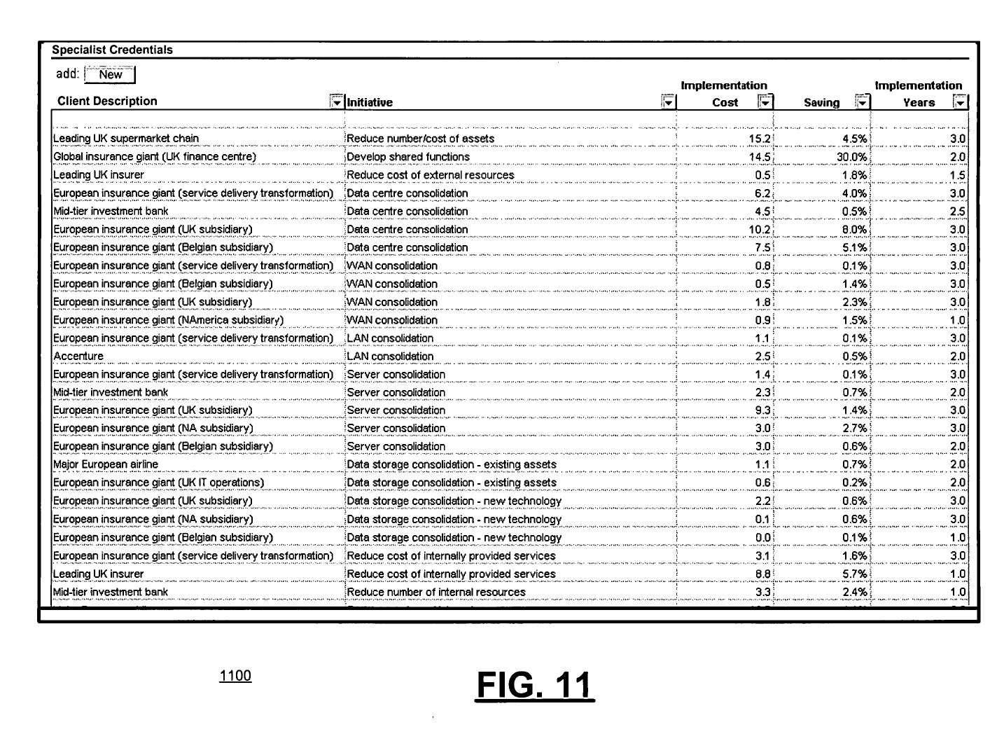

FIG. 11 is an illustration of a credentials user view 1100 for displaying and modifying stored credentials data relating to project initiatives as may be produced by the assessment tools according to a preferred embodiment of the present invention. As illustrated, user view 1100 appears to be a data file as viewed from a standard spreadsheet-like interface. The user could add new initiative credentials records (with accompanying credentials data) or update existing records in the data file, which are then automatically incorporated by the various assessment tools during subsequent operation.

Referring again to FIG. 5, as described above, the assessment system 500 can optionally include external application programs that can electronically receive various outputs from the assessment tool program 501. These optional application programs can include a word processor 507, a presentation program 508, a graphics program 509 and a spreadsheet program 510. Such application programs need not be of any particular type, so long as they are capable of receiving electronic inputs in various formats, including graphical picture formats, plain or rich formatted text, delimited data and other common data interchange types.

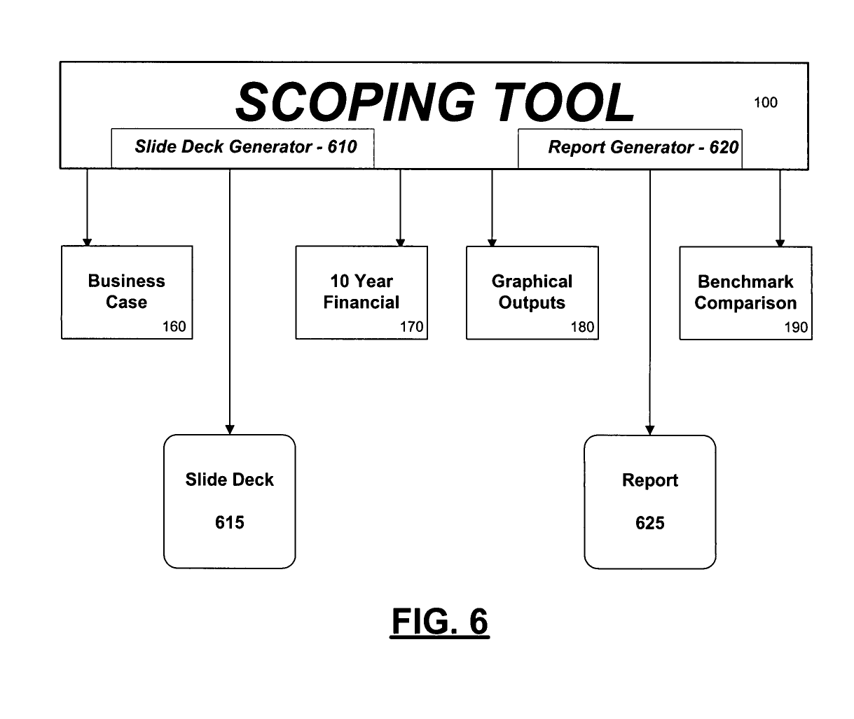

As certain outputs will, in addition to being displayed by the various assessment tools, be available for printing or exporting in two different fashions, this aspect is conceptually depicted in the schematic diagram of FIG. 6. In one such embodiment, one or more pre-programmed macros will automatically assemble and print out data and graphs from either the scoping tool 100 or the shaping tool 300. For instance, scoping tool 100 may further comprise a slide deck generator 610 and/or a report generator 620 (shaping tool 300, while not depicted, could likewise contain similar elements). The slide deck generator 610 automatically prints out (or generates in a transferable electronic format) a slide deck 615 which is a short report including some or all of the graphical outputs 180. This provides an easy way to compare the IT transformation results to the present IT infrastructure and share the information with members of the target organization or specialist organization. The slide deck 615 may also include such background items as the date and names of the business and users.

Report generator 420 similarly serves the function of automatically printing out (or generating in a transferable electronic format) a more extensive report 625 including some representations or reproduction of the various inputs and outputs. The report 425, while much longer and more detailed, also contains the similar information provided in the slide deck 615. The advantage of the report 465 is that it shows the assumptions and data relied upon to come to the conclusions that the scoping tool 100 has produced.

While exemplary embodiments of the invention have been shown and described herein, it will be obvious to those skilled in the art that such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only in the spirit and scope by the claims as appended hereto.

1. An electronic assessment system for analyzing potential costs and benefits of at least one change to a target business' IT capabilities according to a transformation plan, said assessment system comprising;
a library containing a collection of various project initiatives that serve to identify optional projects that could be implemented to change the IT capabilities of a business, said library further containing credentials data associated with each said project initiative, said credentials data detailing historic data and conclusions regarding various relevant projects previously implemented by members of an organization specializing in managing changes to IT capabilities;
a scoping tool in communication with said library and adapted receive inputs describing the status of and IT capabilities of a target company, said scoping tool further being adapted to allow a user to investigate project initiatives contained in said library and thereby select appropriate ones of said initiatives for inclusion in a proposed transformation plan, said scoping tool further being adapted to permit said user to prepare an estimate of the costs and benefits of said proposed transformation plan using said inputs and to modify said selected initiatives in response to said estimated costs and benefits, and said scoping tool further being adapted to permit said user to adopt a proposed transformation plan once said estimated costs and benefits are acceptable; and
a shaping tool in communication with said scoping tool and said library, said scoping tool being adapted to receive said inputs and said adopted transformation plan from said scoping tool, to prompt the user for and to receive additional inputs regarding said target business and being relevant to project initiatives contained in said adopted transformation plan, and to generate outputs that provide a detailed forecast regarding the expected impact of said adopted transformation plan.

2. The assessment system of claim 1, further comprising at least one user interface for the acceptance of said inputs and said additional inputs and the display of said estimated costs and benefits and said detailed forecast outputs.

3. The assessment system of claim 1, further comprising at least one user interface for the management of said project initiatives and associated credentials data stored in said library.

4. The assessment system of claim 1, wherein said credentials data associated with a given project initiative in said library provides historic data regarding savings and costs experienced in conjunction with one or more prior implementations of said given project initiative.

5. The assessment system of claim 4, wherein said one or more prior implementations of said given project initiative were managed by said organization.

6. The assessment system of claim 1, wherein said inputs for said scoping tool include initial inputs including financial metrics data of the target business, baseline data regarding the IT activities of the target business, and data regarding relevant ongoing projects managed by said target business.

7. The assessment system of claim 6, wherein said inputs further include information requested by said scoping tool as specifically pertaining to said selected project initiatives contained in said proposed transformation plan or said adopted transformation plan.

8. The assessment system of claim 6, wherein said estimated costs and benefits of a proposed transformation plan includes a comparison of savings produced by said selected project initiatives in relation to said current IT baseline data.

9. The assessment system of claim 8, wherein said savings are calculated using said inputs and said credentials data.

10. The assessment system of claim 9, wherein said scoping tool further utilizes industry benchmark data in calculating said savings.

11. The assessment system of claim 1, wherein said estimated costs and benefits are calculated by said scoping tool based upon said inputs and said credentials data.

12. The assessment system of claim 11, wherein said scoping tool further utilizes industry benchmark data in calculating said estimated costs and benefits.

13. The assessment system of claim 1, wherein said inputs and said additional inputs can be obtained from documents selected from the group consisting of corporate policy and financial documents, general ledgers, accounts payable documents, payroll documents, application and technical architecture documents, and organizational charts.

14. The assessment system of claim 1, wherein said scoping tool and said shaping tool are computer applications running on a spreadsheet computer platform.

15. The assessment system of claim 1, wherein said scoping tool is adapted to assist said user in selecting project initiatives for inclusion in a proposed transformation plan by providing viewable overview information for each project initiative in said library.

16. The assessment system of claim 1, wherein said scoping tool is adapted to assist said user in whether to select a given project initiative being investigated for inclusion in a proposed transformation plan by requesting the user to enter qualitative assessment inputs of said target business, said qualitative assessment inputs being customized for said given project initiative being investigated, and wherein said scoping tool uses said qualitative assessment inputs with said inputs and said credentials data to produce an estimated impact of said project initiative being investigated.

17. The assessment system of claim 1, wherein said scoping tool provides various outputs selected from the group consisting of high-level business cases, estimated 10 year financials, graphical charts and diagrams, and comparisons to benchmark data.

18. The assessment system of claim 17, wherein said outputs can be viewed, printed, or exported electronically.

19. The assessment system of claim 1, wherein said detailed forecast comprises a full business case regarding the expected impact of project initiatives in said adopted transformation plan and supporting graphical renderings of forecast data in said plan.

20. The assessment system of claim 1, wherein said scoping tool and said shaping tool provide default values for particular ones of said inputs and said additional inputs, said default values being set according to said credentials data.

21. The assessment system of claim 1, wherein said detailed forecast can be updated by said user at a later time by revising said inputs and said additional inputs in light of emerging data regarding said target business or project initiatives included in said adopted transformation plan.

22. A method of improving IT capabilities of a business by quantifying potential costs and benefits of possible alternative changes within said business to identify a suitable plan, said method comprising:
inputting relevant data regarding a target business into an automated scoping tool, said relevant data evidencing the status of and IT capabilities of said target company;
investigating alternative project initiatives contained in an electronic library accessible via said scoping tool, said library containing a collection of said project initiatives that each identify a project that could be implemented to change the IT capabilities of a business, said library further containing credentials data associated with each said project initiative, said credentials data detailing historic data and conclusions regarding various relevant projects previously implemented by members of an organization specializing in managing changes to IT capabilities, and said scoping tool displaying project initiative overview information to assist in investigating said project initiatives wherein said overview information is derived from said relevant data inputs and said credentials data;
selecting appropriate ones of said project initiatives in said library for inclusion in a proposed transformation plan using said scoping tool, said selecting taking into account said overview information, and said scoping tool thereby requesting additional data required to analyze initially each of said selected project initiatives;
inputting said additional data requested by said scoping tool, said scoping tool thereby automatically performing calculations based upon said relevant data inputs, said additional data inputs, and said credentials data and thereby preparing an estimate of the costs and benefits of said proposed transformation plan;
modifying said selected project initiatives in said proposed transformation plan until said estimated costs and benefits are acceptable; and
adopting said proposed transformation plan once said estimated costs and benefits are acceptable, said adopted transformation plan containing a final selection of project initiatives.

23. The method of claim 21, further comprising:
inputting said relevant and additional data, said credentials data, and details regarding said adopted plan into an automated shaping tool, said shaping tool thereby prompting for more in-depth data, said more in-depth data being relevant to said finally selected project initiatives;
inputting more in-depth data inputs regarding said target business, said shaping tool thereby automatically generating outputs that provide a detailed forecast regarding the expected impact of said adopted transformation plan.

24. The method of claim 23, wherein said detailed forecast comprises a full business case regarding the expected impact of project initiatives in said adopted transformation plan and supporting graphical renderings of forecast data in said plan.

25. The method of claim 23, wherein said scoping tool and said shaping tool provide default values for particular ones of requested inputs, said default values being set according to said credentials data.

26. The method of claim 23, further comprising updating said detailed forecast to include emerging data regarding said target business or progress data regarding implementation of said finally selected project initiatives, said updating being performed by revising said relevant and additional and more in-depth data inputs as said emerging data and said progress data become available.

27. The method of claim 22, wherein said credentials data associated with a given project initiative in said library provides historic data regarding savings and costs experienced in conjunction with one or more prior implementations of said given project initiative.

28. The method of claim 27, wherein said one or more prior implementations of said given project initiative were managed by said organization.

29. The method of claim 22, wherein said relevant data input into said scoping tool includes financial metrics data of the target business, baseline data regarding the IT activities of the target business, and data regarding relevant ongoing projects managed by said target business.

30. The method of claim 29, wherein said estimated costs and benefits of a proposed transformation plan includes a comparison of savings produced by said selected project initiatives in relation to said current IT baseline data.

31. The method of claim 30, wherein said savings are calculated using said relevant data and said additional data and said credentials data.

32. The method of claim 31, wherein said scoping tool further utilizes industry benchmark data in calculating said savings.

33. The method of claim 22, wherein said scoping tool further utilizes industry benchmark data in calculating said estimated costs and benefits.

34. The method of claim 22, further comprising obtaining said relevant data and said additional data from documents selected from the group consisting of corporate policy and financial documents, general ledgers, accounts payable documents, payroll documents, application and technical architecture documents, and organizational charts.

35. The method of claim 22, wherein said scoping tool is adapted to assist in whether to select a given project initiative being investigated for inclusion in said proposed transformation plan by requesting the inputting of qualitative assessment inputs concerning said target business, said qualitative assessment inputs being customized for said given project initiative being investigated, and wherein said scoping tool uses said qualitative assessment inputs with said inputs and said credentials data to predict and display an estimated impact of said project initiative being investigated.

36. The method of claim 22, wherein said scoping tool is adapted to provide various outputs selected from the group consisting of high-level business cases, estimated 10 year financials, graphical charts and diagrams, and comparisons to benchmark data.

37. The method of claim 36, wherein said outputs can be viewed, printed, or exported electronically.
